(19) United States
(12) Patent Application Publication
(10) Pub. No.: US 2023/0170993 A1
(43) Pub. Date: Jun. 1, 2023

(54) MODE-DIVISION MULTIPLEXED FIBER RAMAN AMPLIFIER SYSTEM AND METHOD

(71) Applicants: Mario Zitelli, Rome (IT); Stefan Wabnitz, Rome (IT)

(72) Inventors: Mario Zitelli, Rome (IT); Stefan Wabnitz, Rome (IT)

(21) Appl. No.: 17/815,270

(22) Filed: Jul. 27, 2022

Related U.S. Application Data
(60) Provisional application No. 63/284,445, filed on Nov. 30, 2021.

(51) Int. Cl. H04B 10/2537; H04J 14/04; H04B 10/2581

(52) U.S. Cl. CPC H04B 10/2537; H04J 14/04; H04B 10/2581

(57) ABSTRACT

A system for the Raman amplification of mode-division multiplexed optical signals at the telecom wavelengths in multimode optical fibers, and a method. A mode-division multiplexer (105) is used at the input of a multimode fiber (107) to inject signals (101), and continuous-wave pump waves at lower wavelength (102), on the different transverse modes of the fiber. A second mode-division multiplexer (106) is used at the output of the fiber to extract the amplified signals (103). The amplification of one or more signals is accomplished by inter-modal and intra-modal stimulated Raman scattering occurring between the fiber transverse modes carrying the signals and those carrying the pumps.

### CROSS-REFERENCE TO RELATED APPLICATIONS

This application claims the benefit of PPA U.S. Ser. No. 63/284,445, filed Nov. 30, 2021 by the present inventors.

### FEDERALLY SPONSORED RESEARCH

Not Applicable

### SEQUENCE LISTING OR PROGRAM

Not Applicable

### FIELD OF THE INVENTION

This invention relates to optical amplification in lightwave communication systems. More particularly, this invention relates to a method and a system for the Raman amplification of mode-division multiplexed optical signals at telecom wavelengths in multimode optical fibers.

### BACKGROUND OF THE INVENTION

Multimode fibers (MMFs) have recently attracted considerable interest, motivated by their potential for increasing the transmission capacity of long-distance optical links via the technique of mode-division-multiplexing (MDM); in MDM, several transverse modes of the fiber are selectively used as information carriers. Moreover, MMFs show increased tolerance to high signal powers with respect to single mode fibers. The system capacity, expressed in bits/symbol, scales as C=M·log₂(1+OSNR), with M the number of multiplexed modes and OSNR the carrier signal-to-noise ratio. Hence, both the use of MDM and the amplification of the signal carriers are advantageously used to increase the system capacity.

Raman amplification in monomodal optical fibers is commercially available, and was proposed in several patents like, for example, U.S. Pat. No. 7,199,919 to Emori et al., issued Apr. 3, 2007. The advantage of using distributed Raman amplification, with respect to lumped amplification by erbium-doped fiber amplifiers (EDFA), is provided by the improved OSNR which is obtainable by using distributed gain. As it is well known in the literature, Raman amplifiers also offer a wider wavelength band with respect to EDFAs, but the gain is relatively small and, therefore, it is preferable to use a high output laser device as a pumping source. Pump power is however limited, at a single frequency, by stimulated Brillouin scattering and increased noise at high power values; longitudinal multimode pump lasers are conveniently used for injecting into the monomodal transmission fiber pump power at several wavelengths; more pump lasers at different wavelengths can be used to further increase the injected pump power; simultaneous co-propagating and counter-propagating pump power injection can be used to overcome the problem of pump power absorption in the transmission fiber.

Despite the presence of the several techniques that have been adopted in single mode fiber systems to increase the injected pump power, this is intrinsically limited by thermal effects caused by the pump power concentration into the small core area of a monomodal fiber, which is typically of the order of 80 μm² or less. To the contrary, a much larger pump and signal power can be injected into the core of commercial MMFs, both with graded-index profile (GRIN), parabolic index, or with step-index profile (SI); the core area in those fibers may reach a value of 2000 μm² or more, permitting a pump power injection which is 25 times larger than what is available with a commercial single mode fiber, or more.

In U.S. patent application Ser. No. 11/653,818 to Rice et al. published Jul. 17, 2008, entitled “Multimode Raman waveguide amplifier”, a Raman multimode waveguide amplifier was proposed, principally for ladar applications. However, the proposed system was not fiber-based, and comprised a planar multimode waveguide where both the input signal and pump power were coupled with no modal multiplexing devices. Signal was not modulated for telecom applications, and wavelength was preferably chosen around 2.94 μm.

In U.S. Pat. No. 6,363,087 to Rice et al., issued Mar. 26, 2002, entitled “Multimode Raman fiber amplifier and method”, a Raman fiber amplifier was proposed injecting a signal beam in a multimode inner core of a dual clad optical fiber, and the pump power in the multimode outer core; an outer cladding confined the pump power in the outer core. In this amplifier, signal and pump were injected into different cores, with no modal multiplexing, nor modal selection at input.

In U.S. Pat. No. 7,397,599 to Bourova et al., issued Jul. 8, 2008, entitled “Doped-ring amplifying optical fiber, and an amplifier containing such a fiber”, a double-clad Raman fiber amplifier was proposed comprising a single-mode core and an outer rare earth ions doped multimode core. Amplification was obtained both by Raman gain and by dopant emission. However, no mode-division multiplexing nor single core fibers were used.

In paper [A. Polley, S. E. Ralph, “Raman amplification in multimode fiber”, IEEE Phot. Tech. Lett. 19(4), 2007] the Raman amplification of a signal in GRIN MMF was investigated, confirming that the radial dependence of the Raman gain coefficient promotes the amplification of the fiber's transverse fundamental mode LP₀₁ with respect to the higher order modes (HOM). In the paper, a signal at 10 Gbit/s repetition rate and at 1550 nm wavelength, and a continuous wave pump (CW) at 1455 nm, were both injected into the MMF using a standard monomodal fiber (SMF) for input injection. However, no mode-division multiplexing nor a selective use of the fiber modes for signals and pumps were used.

In paper [L. Graini, B. Ortag, “Spatiotemporal evolutions of similaritons pulses in multimode fibers with Raman amplification”, Photonics 2021, 8, 354], the nonlinear evolution of optical pulses in a GRIN-MMF with Raman gain was investigated. Signal was launched with 1060 nm wavelength, distributed over 6 fiber modes, and with 2 ps Gaussian temporal profile; the CW pump power had 1010 nm wavelength; both were injected at the fiber input using a coupler. However, no mode-division multiplexing, nor mode selection was proposed, nor telecom wavelengths were used for the signal.

In paper [A. G. Kuznetsov, I. N. Nemov, A. A. Wolf, S. I. Kablukov, S. A. Babin, Y. Chen, T. Yao, J. Leng, P. Zhou, “Beam cleaning effects in multimode GRIN-fiber Raman lasers and amplifiers”, Journal of Physics, Conference series 1508 (2020) 012009], a kW laser was demonstrated. GRIN-MMF with 62.5 μm core diameter was pumped by CW lasers with 1018 nm wavelength and overall power up to 800 W. The amplified signal had 1060 nm wavelength and could reach 530 W output power in CW regime. However, the demonstration was intended for high power source applications instead of telecom, and no use of modal multiplexing nor mode selection was proposed.

In conference paper [P. M. Krummrich, K. Petermann, “Evaluation of Potential Optical Amplifier Concepts form Coherent Mode Multiplexing”, Proc. of OFC 2011, OMH5 (2011)], a multimode and a multicore fiber pumping schemes were proposed for Raman amplification, based on modal separation and coupling using fiber tapers and GRIN lenses. Pump radiation was injected using dichroic mirrors in free-space propagation, after modal separation by fiber tapers and GRIN lenses. However, pump radiation was not injected on selected modes directly using mode-division multiplexers.

None of the inventions or papers described above performs a mode selection of the signal and the pump at the input of the fiber, directly using mode-division multiplexers. Hence, none of those amplification systems is compatible with the previously described MDM technique for telecom applications, directly using mode-division multiplexers for pump injection.

### BRIEF SUMMARY OF THE INVENTION

### Objects and Advantages

The invention relates to a system and method in which at least one digital optical signal is transmitted in a multimode optical fiber, experiencing Raman amplification in the fiber core, after being mode-division multiplexed together with several pump beams with lower wavelength.

Accordingly, several objects and advantages of the invention are:

(a) the possibility of mode-multiplexing at the input of the fiber, and de-multiplexing at the output, one or more signal modes which experience inter-modal Raman amplification, fed by the multiplexed pump modes;

(b) Raman amplification of mode-multiplexed signals is obtained by injecting pumps directly using mode-division multiplexers;

(c) the amplification method is compatible with the MDM technique;

(d) the individual output signals are isolated from the other signals and from the pumps, directly using the output mode-demultiplexer, and only eventually by optical filters and adders following the demultiplexer:

(e) the pump power distributed among the several modes of the fiber can be of tens or hundreds of Watts, therefore extending the length of the repeaterless (unrepeatered) transmission systems well beyond the limits of the single-mode fiber systems;

(f) the aggregated transmission capacity is increased by a factor M, with M the number of mode-multiplexed signals per wavelength;

(g) pump power efficiency is improved by the use of the fiber core, instead of the fiber cladding, for pumps injection.

In a first aspect of the invention, the system is composed by an input mode-division multiplexer, able to couple the incoming signals and pumps to different transverse modes of a multimode fiber connected to the multiplexer. A digital optical signal is typically composed by high repetition-rate pulses, at a single telecom wavelength (by way of example, 1550 nm), or by a superposition of digital signals at different wavelengths, resulting from a previous wavelength-division multiplexing (WDM) of optical signals. A pump input is typically composed by a continuous-wave (CW) beam at a lower wavelength with respect to the signals (by way of example, 1450 nm); possibly, pumps have slightly different wavelengths, in order to distribute the Raman gain over a larger bandwidth.

The signals propagating over different modes of the optical fiber experience gain caused by the Stimulated Raman Scattering (SRS) process; each pump transfers power to each signal by a different inter-modal scattering process; hence, multiple SRS processes permit the depletion of the pump modes, and the simultaneous amplification of multiple signal modes (each carrying a single, or multiple wavelengths).

An output mode-division multiplexer is connected to the multimode fiber and is able to extract the incoming fiber modes to separate signals and/or pumps, the last ones possibly with negligible power. Eventually, it is possible to inject pump modes from the output multiplexer into the fiber (counter-propagating pumps) because the multiplexer is totally passive, and it acts symmetrically in the two directions. This second injection helps counteracting pump absorption caused by fiber losses and by the Raman gain process itself.

The optical signals at the output of the mode-division multiplexer may result temporally broadened by the cumulated chromatic dispersion of the fiber; eventually, the broadening can be compensated by optical dispersion compensators placed at the receiver side and/or at the transmitter side, or by electronic digital signal processing devices (DSP).

In a second aspect of the invention, some signals and pumps are coupled together, before being coupled to the same transverse mode of the optical fiber. According to this aspect, some of the modes propagating in the fiber will be carrying only a signal, some only a pump, and some others will carry both a signal and a pump. At the output, optical filtering is eventually necessary in order to isolate the signal and the pump emerging from the same mode.

In a third aspect of the invention, signals are coupled to non-degenerate modes of the optical fiber, consisting of modes with different propagation constants. Linear random-mode coupling that affects fiber transmission may be responsible for the scrambling of the power of each signal among adjacent degenerate modes, characterized by having similar propagation constants. After the output multiplexer, the optical powers of degenerate modes are collected with no separation, or eventually added by an optical coupler, thus recovering the amplified signal.

A further aspect of the invention provides a method for using MDM to inject and extract signals and pumps into the multimode fiber (typically a GRIN or SI fiber). Parallel inter-modal SRS processes permit to speed-up the power conversion from the pump to the signal modes. Intra-modal SRS is also active if pump and signal share the same mode at different wavelengths. The said method is conveniently used to amplify signals in optical systems according to the first, second and third aspects of the invention.

### BRIEF DESCRIPTION OF THE SEVERAL VIEWS OF THE DRAWING

The following figures illustrate better the present invention by way of example and without restrictions, detailed descriptions will be given in the following section:

FIG. 1 illustrates a transmission system according to a first aspect of the present invention, where both signals and pumps are multiplexed on different fiber modes.

FIG. 2 illustrates a transmission system according to a second aspect of the present invention, where only some pump beams are multiplexed on different fiber modes with respect to the signals.

FIG. 3 illustrates a transmission system according to a third aspect of the present invention, where degenerate modes are added together at the output, in order to recover the amplified signal.

FIG. 4 reports an example of mode power amplification, numerically evaluated in the case of transmission over a 30 km span of GRIN fiber, according to the first aspect of the present invention.

FIG. 5 reports the output optical pulses for three amplified signals, numerically evaluated in the case of transmission over a 30 km span of GRIN fiber, according to the first aspect of the present invention.

### DETAILED DESCRIPTION OF THE INVENTION

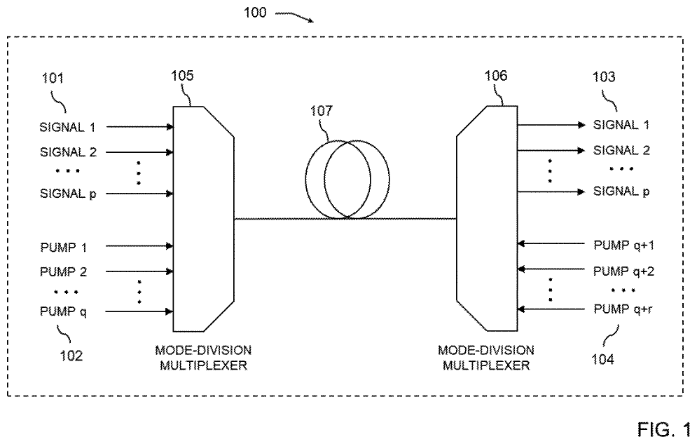

The scheme of FIG. 1 includes a system 100 for the Raman amplification of mode-division multiplexed optical signals at the telecom wavelengths in multimode optical fibers, according to one embodiment of the present invention, the system 100 comprising:

a) an input mode-division multiplexer 105, having at input one or more optical signals 101, and one or more pumps 102 composed by substantially continuous-waves at lower wavelengths with respect to the signals, the multiplexer 105 being able to couple the incoming signals and pumps to different transverse modes of a multimode optical fiber;

b) a multimode optical fiber 107 optically connected to the multiplexer 105, able to propagate several transverse modes corresponding to the signals 101 and pumps 102, and transfer power from the pumps to the signals by parallel processes of inter-modal stimulated Raman scattering;

c) an output mode-division multiplexer 106, optically connected to the optical fiber 107, able to extract the signals 101 propagating on different transverse modes into separated output signals 103 resulting optically amplified.

Eventually, the output multiplexer 106 is used also as an input device for additional pumps 104, that are injected into the optical fiber 107 on several transverse modes in counter-propagating configuration.

The number p of signals 101 and the number q of pumps 102 at the input of the multiplexer 105, as well the number r of pumps at the input of the multiplexer 106 is represented in FIG. 1 by way of example and without restrictions, and it is meant to be extended to an arbitrary number of signal and pump modes injected into the multimode fiber 107. Also, the assignment of the signals and pumps to the fiber modes is meant to be without restrictions.

The mode-division multiplexers 105, 106 are commercially available, and use for example the multi-plane light conversion (MPLC) technology (U.S. Pat. No. 9,250,454) to convert M single-mode input beams into M modes of a multimode fiber, with M=p+q in the example of the multiplexer 105. The inputs are fed, for example, using M single mode fibers (SMF); the output enters the multimode fiber used for transmission (preferably GRIN or SI fiber). Multiplexers of this type can generate several types of fiber modes, which better fit to the connected multimode fiber: LP modes, Hermite-Gauss modes, or Laguerre-Gauss modes. The multiplexer is completely passive and symmetric, so that the same device can be used for multiplexing or de-multiplexing, or for mixed use. Hence, the multiplexers 105, 106 are characterized by the coupling of the individual inputs to different transverse modes of the fiber 107, or decoupling different modes to separated outputs.

The multimode fiber 107 can be a GRIN fiber with parabolic index profile; generally, but not necessarily, commercial fibers of this type have a numerical aperture NA≈0.2, the diameters of the core/cladding are 50/125 μm or 62.5/125 μm, the relative index difference between core and cladding is of the order of Δ=0.01. Alternatively, the multimode fiber 107 can be a SI fiber with diameters of the core/cladding of 50/125 μm or 62.5/125 μm, and generally a numerical aperture NA≈0.2. Preferably, the multimode fiber 107 is a few-mode fiber (FMF) with reduced core size and graded-index profile, capable of transmitting a reduced number of modes, typically, but not necessarily, between 9 and 55 modes.

The fiber core is preferably, but not necessarily based on silica or on fluoride glass, and it can be doped by dopants that contribute to high Raman amplification efficiency, such as germanium, phosphorous, tellurium, aluminum, and boron.

The length of the fiber 107 must be large enough to permit an efficient power transfer from the pump modes to the signal modes, and it is dependent on the pump and signal input powers, as well as on the choice of the signal modes. Preferably, but not necessarily, the pump power is larger than 200 mW per mode to stimulate sufficient inter-modal SRS. The fiber length is generally larger than 100 m.

The signal modes 101 are preferably, but not necessarily, chosen among those with axial symmetry (the modes LP₀ₘ, with m=1, 2, 3 . . . , according to the definitions provided after Eq. 3), because they have higher gain when pumped by the non-axial modes. The signals 101 may be encoded by different types of optical modulation, such as non-return-to zero (NRZ), return-to zero (RZ), differential phase-shift keying (DPSK), as well other types of multilevel modulation.

Preferably, the encoded symbols in the signals 101 are carried by optical pulses of RZ type, and pulses in each mode are launched with the energy of a single-mode soliton for the specific mode; the energy is given by

$${E}_{1} = \frac{λ \vert {β}_{2} ( λ ) \vert {w}_{e}^{2}}{{n}_{2} {T}_{0}} , \qquad ( 1 )$$

with λ the wavelength, β₂(λ) the fiber dispersion at the signal wavelength (s²/m), wₑ the effective waist of the signal mode, n₂ (m²/W) the Kerr nonlinear index of the fiber, and T₀ is the signal pulsewidth. Each transmitted signal possesses different soliton energy, depending on the propagating mode and wavelength.

Eventually, the signals 101 are composed by several wavelengths according to the wavelength-division multiplexing technique (WDM), with each wavelength carrying an information channel; a WDM signal is applied to one input of the mode-division multiplexer 105.

Eventually, both the signals 101 and pumps 102, 104 may be distributed on both transverse polarization axis; signals 101 may be polarization-division multiplexed (PDM).

Typically, the pumps 102, 104 are generated by one or more CW semiconductor lasers emitting at a lower wavelength with respect to the signals. Preferably, the pumps' wavelength is approximatively 100 nm lower respect to the signals' wavelength (for example, 1450 nm if the signals have 1550 nm wavelength); different pumps may possess different wavelengths (for example, pump wavelengths may be distributed between 1430 and 1525 nm); the CW lasers preferably emit over a multitude of longitudinal laser modes.

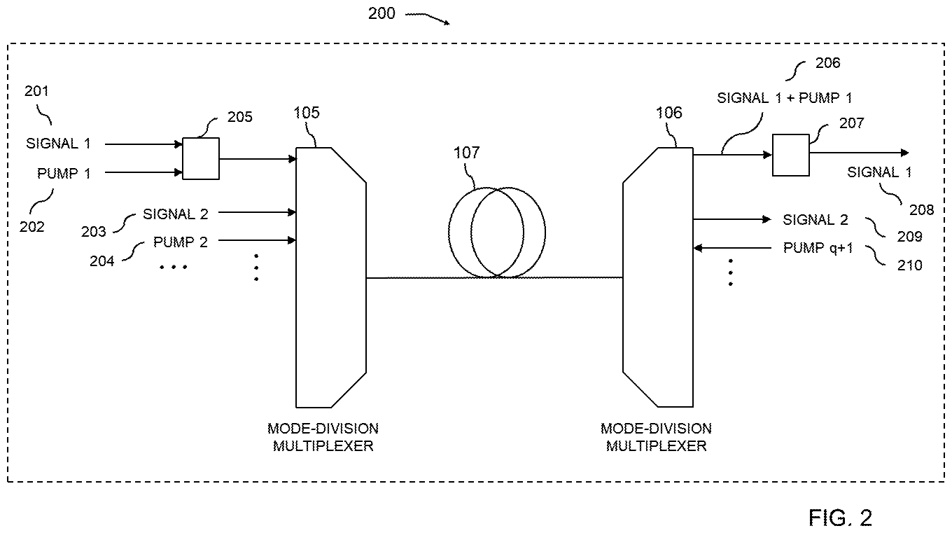

The scheme of FIG. 2 includes a system 200 for the Raman amplification of mode-division multiplexed optical signals at the telecom wavelengths in multimode optical fibers, according to a second embodiment of the present invention, the system 200 comprising:

a) an input mode-division multiplexer 105, having at the input one or more optical signals 201, 203, and one or more pumps 202, 204 composed by substantially continuous-waves at lower wavelength with respect to the signals, the multiplexer 105 being able to couple the incoming signals and pumps to different transverse modes of a multimode optical fiber;

b) at least one optical coupler 205, each one combining one of the signals 201 and one of the pumps 202, and optically connected to one input of the multiplexer 105;

c) a multimode optical fiber 107 optically connected to the multiplexer 105, able to propagate several transverse modes corresponding to the signals 201, 203 and pumps 202, 204 and transfer power from the pumps to the signals by parallel processes of intra-modal and inter-modal stimulated Raman scattering;

d) an output mode-division multiplexer 106, optically connected to the optical fiber 107, able to extract the signal 201 and pump 202 propagating on a same transverse mode into a same output 206, optically connected to an optical filter 207;

e) the optical filter 207 able to block the pump 202 and transmit the amplified signal 208;

e) a number of signals 203 and pumps 204, 210, coupled into the fiber by the multiplexers 105, 106 on different fiber modes.

The optical coupler 205 is composed, for example, by a polarization independent fused fiber optic coupler with coupling factor 0.5; alternatively, but not exclusively, it may be composed by an optical add-drop multiplexer (OADM) with add functionality.

The optical filter 207 consists of, for example, an optical long-pass filter; alternatively, but not exclusively, it may be composed by an optical add-drop multiplexer (OADM) with drop functionality for the signal 208.

Further characteristics of system in FIG. 2 have been described in relation to the first embodiment of the present invention; for the details, reference should be made to the preceding text.

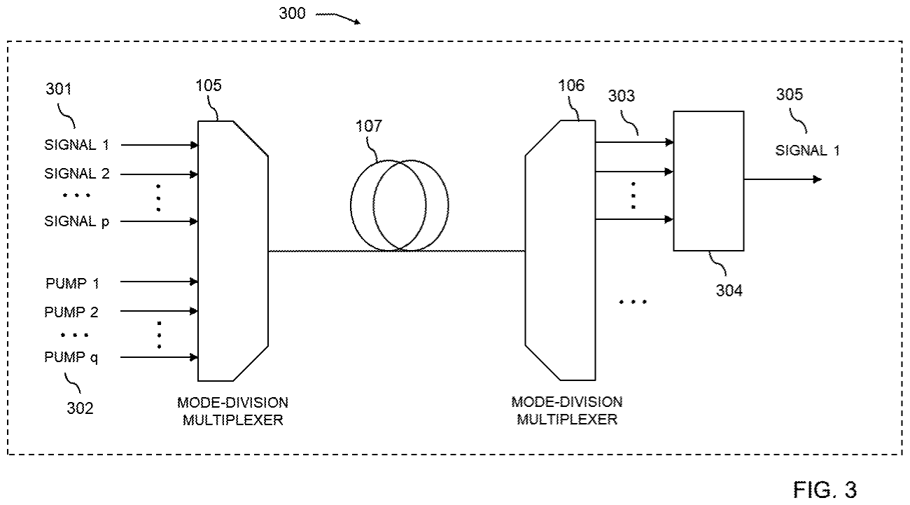

The scheme of FIG. 3 includes a system 300 for the Raman amplification of mode-division multiplexed optical signals at the telecom wavelengths in multimode optical fibers, according to a third embodiment of the present invention, the system 300 comprising:

a) an input mode-division multiplexer 105, having at input one or more optical signals 301, and one or more pumps 302 composed by substantially continuous-waves at lower wavelengths with respect to the signals, the multiplexer 105 being able to couple the incoming signals and pumps to different transverse modes of a multimode optical fiber, the signals 301 being coupled to non-degenerate modes;

b) a multimode optical fiber 107 optically connected to the multiplexer 105, able to propagate several transverse modes corresponding to the signals 301 and pumps 302 and transfer power from the pumps to the signals by parallel processes of intra-modal and inter-modal stimulated Raman scattering, the propagation in the optical fiber 107 being subject to linear random-mode coupling;

c) an output mode-division multiplexer 106, optically connected to the optical fiber 107, able to extract the signals 301 scrambled over more degenerate modes 303 of the fiber;

d) at least one optical coupler 304, optically connected to the multiplexer 106, collecting the outputs corresponding to one input signal, the outputs 303 being degenerate modes of the fiber 107, the coupler 304 having at output one amplified signal 305 resulting from the sum of the modes 303;

e) a number of signals and pumps coupled into the fiber by the multiplexers 105, 106 on different fiber modes.

The optical coupler 304 is composed, for example, by polarization independent fused fiber optic couplers. Alternatively, the coupling of degenerate modes is directly implemented into the output mode-division multiplexer 106, which implement the technique of mode-group demultiplexing.

Further characteristics of system in FIG. 3 have been described in relation to the first embodiment of the present invention; for the details, reference should be made to the preceding text.

The system according to the third embodiment of the invention accounts for possible power transfer, from one signal mode at the fiber input to the adjacent modes with similar propagating constant, commonly referred to as degenerate modes. Mode coupling does not affect the amplification of the signal by inter-modal SRS. At output, the coupler 304 adds the power from the degenerate modes 303 corresponding to one signal, recovering the amplified signal 305. In systems of this type, the different signals 301 at input must be mode-division multiplexed into non-degenerate modes of the optical fiber 107; one optical coupler is needed at the output for each transmitted signal.

In a further embodiment of the invention, the signals 101 are polarization-division multiplexed (PDM), before being multiplexed into the fiber modes. At the output of the mode-division multiplexer 106, the two polarizations of the output signals 103 are separated by polarizing beam splitters (not shown), and distinctly processed.

In another aspect, the present invention relates to a method for the Raman amplification of mode-division multiplexed optical signals at the telecom wavelengths in multimode optical fibers, comprising the steps of:

a) using mode-division multiplexing to couple signals 101 to different modes of a multimode fiber 107;

b) using mode-division multiplexing to couple pumps 102, 104 to different modes of a multimode fiber 107, in co-propagating or counter-propagating configuration, or both;

c) amplifying the modes of the signals 101 by inter-modal and intra-modal stimulated Raman scattering with the modes of the pumps 102, 104 in the multimode fiber 107;

c) using mode-division demultiplexing to extract the amplified signals 103 from the multimode fiber 107.

The multimode fiber 107 is preferably, but not necessarily, a FMF fiber, a GRIN fiber with parabolic index profile, or a multimode SI fiber. Further characteristics of the components used by the said method have been described in relation to the embodiments of the present invention; for the details, reference should be made to the preceding text.

In the said method, multiple and parallel inter-modal SRS processes permit to speed-up the power conversion from the pump to the signal modes. Intra-modal SRS is also active if pump and signal share the same mode at different wavelengths, or if signals are scrambled among adjacent degenerate modes. Hence, the said method is conveniently used in the systems according to the the embodiments of the invention to amplify optical signals.

In all aspects of the invention, the technologies used for the implementation of the input mode-division multiplexer 105, output mode-division multiplexer 106 and multimode fiber 107 are not an object of the present invention.

The said gain experienced by the signals arise from the inter-modal SRS between pump and signal modes, at different wavelengths. The growth of the Stokes modes (signals) and the depletion of the pump modes are described by the following set of equations [F. Poletti, P. Horak, “Description of ultrashort pulse propagation in multimode optical fibers”, J. Opt. Soc. B 25(10), 2008]:

$$\frac{\partial {A}_{p} ( z , t )}{\partial z} = i {n}_{2} {k}_{0} {\sum }_{l , m , n} {Q}_{plmn} \{ ( 1 - {f}_{R} ) {A}_{l} {A}_{m} {A}_{n}^{*} + {f}_{R} {A}_{l} [ h * ( {A}_{m} {A}_{n}^{*} ) ] \} , \qquad ( 2 )$$

where [symbol] is the fiber length, t the time variable, p, l, m, n span over the indexes of all the involved fiber modes, k₀ the propagation constant in vacuum, f_{R}≈0.18 weights the Kerr and Raman nonlinearities, Aₚ, Aₗ, Aₘ, Aₙ are the field's complex amplitudes of the interacting modes, h(t) is the Raman response function, whose spectrum accounts for the Raman gain [Agrawal, G. P. Nonlinear Fiber Optics 3rd ed. (Academic, 2001)]. The first and second terms into the curly brackets describe the inter-modal four-wave mixing (FWM) caused by the Kerr nonlinearity, and the inter-modal SRS due to the Raman nonlinearity, respectively; the last one being responsible for the inter-modal Raman gain. The nonlinear coupling coefficients Qₚₗₘₙ are obtained by the normalized transverse modal profiles Fₚ(x,y) as

$${Q}_{plmn} = \frac{\int d x d y ( {F}_{p}^{*} {F}_{l} ) ( {F}_{m} {F}_{n}^{*} )}{{[ \int d xdy {\vert {F}_{p} \vert}^{2} \int d xdy {\vert {F}_{l} \vert}^{2} \int d xdy {\vert {F}_{m} \vert}^{2} \int d xdy {\vert {F}_{p n} \vert}^{2} ]}^{1 / 2}} . \qquad ( 3 )$$

In the following, we will call LP₀₁, LP₁₁ₐ, LP_{11b}, LP₂₁ₐ, LP_{21b}, LP₀₂, LP₃₁ₐ, LP_{31b}, LP₁₂ₐ, LP_{12b}, LP₄₁ₐ, LP_{41b}, LP₂₂ₐ, LP_{22b}, LP₀₃, the first 15 transverse modes of a SI fiber. For a parabolic GRIN fiber, the same notation will be used to indicate the first 15 Laguerre-Gauss modes (0,0), (0,−1), (0,1), (0,−2), (0,2), (1,0), (0,−3), (0,3), (1,−1), (1,1), (0,−4), (0,4), (1,−2), (1,2), (2,0) respectively, where indexing (p,m) groups the radial index p and the azimuthal index m of the mode.

Typically, but not necessarily, the system is composed by a single span of multimode fiber; in this case, thanks to the high optical powers allowed by the multimode fiber, the systems according to the said embodiments of the invention are used advantageously to increase the length of repeaterless transmission systems, when compared with traditional single-mode fiber systems.

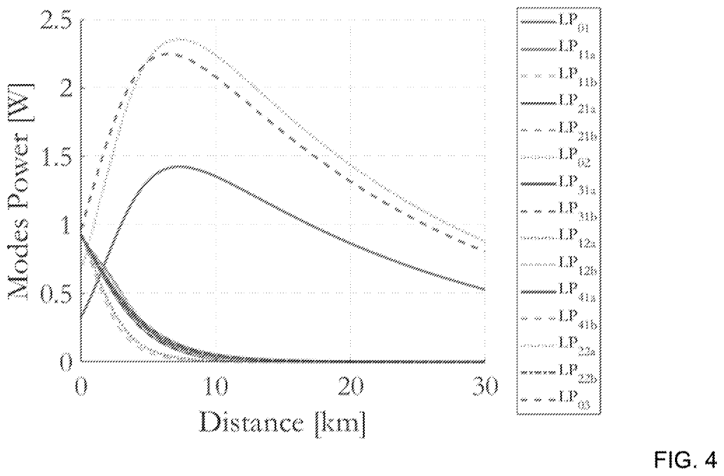

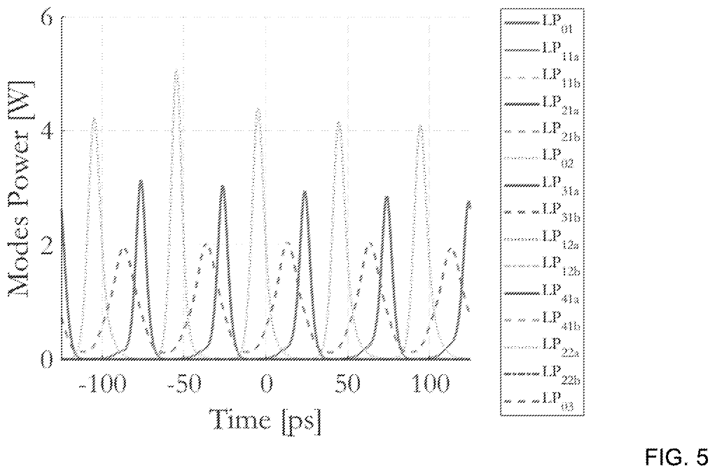

To show this capability, FIG. 4 and FIG. 5 illustrate numerical simulation results obtained using the model of Eq. 2, where second and third order chromatic dispersion, modal dispersion, wavelength-dependent losses, and linear random mode-coupling was further included.

The system of FIG. 1 was simulated, including 30 km of GRIN fiber, with 3 signals injected into the modes LP₀₁, LP₀₂, LP₀₃ characterized by axial symmetry, which resulted the most suitable to be amplified by the other, non-axial modes.

The considered fiber was a parabolic GRIN multimode fiber with 50/125 μm diameters, NA=0.20, dispersion and nonlinearity parameters β₂=−28.8 ps²/km, β₃=0.142 ps²/km (for the fundamental mode at 1550 nm), n₂=2.7×10⁻²⁰ m²/W, Raman function h(t) with typical response times of 12.2 fs and 32 fs.

The 3 signals were composed by trains of 10 ps pulses at 1550 nm wavelength, with sequences of alternated marks and spaces at baud rate R_{b}=40 Gbaud/s, launched with mode-dependent soliton energy given by Eq. 1; pulse energies for the 3 signal modes were 16.1 pJ, 32.8 pJ, 48 pJ respectively, corresponding to signal mean powers of 322 mW, 656 mW, 960 mW. The aggregated capacity of the system, considering the mode-division multiplexing, was 120 Gbaud/s at a single wavelength.

The pumps were CW beams at 1450 nm wavelength, injected on 12 non-axial modes at the transmitter side only, with 10 W of total power uniformly distributed among the modes (833 mW/mode).

FIG. 4 shows the power evolution of the signals and the pumps. After 15 km of transmission, the pumps are totally depleted, partially because of fiber losses and in part for the SRS net gain towards the 3 signal modes. Signals receive nearly the 60% of the pump power after 8 km of transmission; after that, they start to experience fiber absorption and gradually broaden. During all transmission, pulses from the 3 signals conserve the soliton shape; when amplified, their pulsewidth gradually decreases to maintain the soliton condition given by Eq. 1; the same conservation law holds during the attenuation section, when pulses increase their pulsewidth while adiabatically maintaining the soliton shape. FIG. 5 shows the broadened pulse shape for the 3 signals, after 30 km of transmission.

Eventually, pulse broadening is compensated at the output of the mode-division demultiplexer using, for example optical dispersion compensator devices, or electronic digital signal processing (DSP).

By performing a power budget for a repeaterless system transmitting signals at 40 Gbaud/s, limited by fiber losses and with only co-propagating pump, and considering that pump power in single-mode fiber systems is generally limited to 500 mW, it results that multimode fiber based systems, such as the one proposed according to the embodiments of the invention, with 10 W or 100 W pump power, can increase the transmission distance with respect to single-mode systems by 25% or 44%, respectively.

The aggregated capacity C in systems according to the invention is increased by a factor M, with M the number of mode-multiplexed channels per wavelength. Systems are also compatible with the WDM technique, because several multiplexed wavelengths can be injected in a single mode of the fiber by using the systems according to the embodiments of the invention.

### Advantages

From the description above, a number of advantages of our system, for the Raman amplification of mode-division multiplexed optical signals, become evident:

(a) Raman amplification of mode-multiplexed signals is obtained by injecting pumps directly using mode-division multiplexers.

(b) Amplification of signals multiplexed on different transverse modes of the fiber is feasible for single-wavelength, single-polarization signals, but also for WDM signals and PDM signals.

(c) The amplification method is compatible with the MDM technique.

(d) The individual output signals are isolated from the other signals and from the pumps by the output mode-demultiplexer, and eventually by optical filters and adders following the demultiplexer.

(e) The pump power distributed among the several modes of the fiber can be of tens or hundreds of Watts, therefore extending the length of the unrepeated transmission systems well beyond the limits of the single-mode fiber systems.

(f) Transmission at soliton power is feasible using MDM in multimode fibers, therefore increasing the optical signal-to-noise ratio.

(g) The aggregated capacity, in baud/sec, is increased by a factor M, with M the number of mode-multiplexed signals per wavelength.

(h) Pump power efficiency is improved by the use of the fiber core, instead of the fiber cladding, for pumps injection.

Several changes and adaptations may be made to the present invention by persons with skill in the art. Therefore, the scope of the invention is defined by the appended claims and all changes and modifications falling within the equivalence of the scope of the claims are to be embraced by the invention.

We claim:

1. A system for the Raman amplification of mode-division multiplexed optical signals at the telecom wavelengths in multimode optical fibers, the said system comprising:
a) an input mode-division multiplexer means which has at input one or more optical signals, and one or more optical pumps composed by substantially continuous-waves at lower wavelength with respect to the signals, the said multiplexer being able to couple the incoming signals and pumps to different transverse modes of a multimode optical fiber;
b) a multimode optical fiber, optically connected to the said input multiplexer, able to propagate several transverse modes, each corresponding to one of the said signals or pumps, and transferring power from the pumps to the signals by means of parallel processes of inter-modal stimulated Raman scattering;
c) an output mode-division multiplexer means which is optically connected to the said optical fiber, able to extract the said signals propagating on different transverse modes of the fiber into separated output signals, the said output signals being optically amplified.

2. The system of claim 1 for the Raman amplification of mode-division multiplexed optical signals, wherein the said output multiplexer is used also as an input device for additional pumps, that are injected into the said optical fiber on several transverse modes in counter-propagating configuration.

3. The system of claim 1 for the Raman amplification of mode-division multiplexed optical signals, wherein the said multimode fiber is a few-mode fiber with graded-index profile.

4. The system of claim 1 for the Raman amplification of mode-division multiplexed optical signals, wherein the said multimode fiber is a step-index fiber.

5. The system of claim 1 for the Raman amplification of mode-division multiplexed optical signals, wherein the pump power is larger than 200 mW per mode and the said fiber length is larger than 100 m, in order to stimulate sufficient inter-modal stimulated Raman scattering.

6. The system of claim 1 for the Raman amplification of mode-division multiplexed optical signals, wherein the said signal modes are selected among those with axial symmetry LP₀ₘ, with m a positive integer.

7. The system of claim 1 for the Raman amplification of mode-division multiplexed optical signals, wherein the encoded symbols in the said signals are carried by optical pulses of return-to-zero type, and pulses in each mode are launched with the energy of a single-mode soliton for the specific mode.

8. The system of claim 1 for the Raman amplification of mode-division multiplexed optical signals, wherein the said pumps have wavelength chosen to maximise the amplification of the said signals by inter-modal and intra-modal stimulated Raman scattering.

9. The system of claim 1 for the Raman amplification of mode-division multiplexed optical signals, wherein the said pump power is distributed over both polarizations of the propagating pump modes.

10. The system of claim 1 for the Raman amplification of mode-division multiplexed optical signals, wherein the said signals have wavelengths falling in the C and L bands, between 1530 and 1625 nm, and the said pumps have multiple wavelengths falling between 1430 and 1525 nm.

11. The system of claim 10 for the Raman amplification of mode-division multiplexed optical signals, wherein at least one of the said signals is composed by the wavelength-division multiplexing of several composing signals, the said signal being injected into one mode of the multimode fiber.

12. The system of claim 1 for the Raman amplification of mode-division multiplexed optical signals, further comprising:
a) at least one optical coupler means which combines one of the said signals and one of the said pumps, and which is optically connected to one input of the said input multiplexer, the said signal and pump being multiplexed on a same transverse mode of the said fiber;
b) at least one optical filter means which is optically connected to the said output multiplexer, and which receives at input the amplified signal and the pump multiplexed on a same transverse mode, the said optical filter able to block the said pump and transmit the said amplified signal;
c) a number of signals and pumps coupled into the fiber by the said multiplexers on different fiber modes.

13. The system of claim 1 for the Raman amplification of mode-division multiplexed optical signals, wherein the said output mode-division multiplexer extracts groups of degenerate modes, the said signals propagating on different mode groups being separated into amplified output signals.

14. The system of claim 1 for the Raman amplification of mode-division multiplexed optical signals, further comprising an optical coupler means which is optically connected to the said output multiplexer, and which collects the outputs corresponding to degenerate modes of the said fiber, the said coupler having at output one amplified signal resulting from the sum of the said modes.

15. A method for the Raman amplification of mode-division multiplexed optical signals at the telecom wavelengths in multimode optical fibers, comprising the steps of:
a) using mode-division multiplexing to couple a plurality of signals to different modes of a multimode fiber;
b) using mode-division multiplexing to couple a plurality of pumps to different modes of a multimode fiber, in co-propagating or counter-propagating configuration, or both;
c) amplifying, in the said multimode fiber, the said signal modes by inter-modal and intra-modal stimulated Raman scattering with the said pump modes;
c) using mode-division demultiplexing to extract the amplified signals from the said multimode fiber.

16. The method of claim 15 for the Raman amplification of mode-division multiplexed optical signals, wherein the said mode-division multiplexing at the receiver side is also used as an input method for additional pumps, the said pumps being injected into the said optical fiber on several transverse modes in counter-propagating configuration.

17. The method of claim 15 for the Raman amplification of mode-division multiplexed optical signals, wherein the said mode-division multiplexing at the receiver side extracts groups of degenerate modes including signals, the said signals propagating on different mode groups being separated into amplified output signals.

18. The method of claim 15 for the Raman amplification of mode-division multiplexed optical signals, wherein the encoded symbols in the said signals are carried by optical pulses of return-to-zero type, and pulses in each mode are launched with the energy of a single-mode soliton for the specific mode.

19. The method of claim 15 for the Raman amplification of mode-division multiplexed optical signals, wherein the said pumps wavelengths are lower than the said signal wavelengths, so that it is maximized the amplification of the said signals by inter-modal and intra-modal stimulated Raman scattering.

20. The method of claim 15 for the Raman amplification of mode-division multiplexed optical signals, wherein at least one of the said signals is composed by the wavelength-division multiplexing and by the polarization-division multiplexing of several composing signals, the said signal being injected into one fiber mode.
